(19) United States
(12) Patent Application Publication
(10) Pub. No.: US 2025/0031109 A1
(43) Pub. Date: Jan. 23, 2025

(54) METHOD AND DEVICE FOR OPERATING UPLINK TIME ADJUSTMENT TIMER DURING L1/L2-BASED HANDOVER IN MOBILE COMMUNICATION SYSTEM

(71) Applicant: SAMSUNG ELECTRONICS CO., LTD., Suwon-si (KR)

(72) Inventors: Seungri JIN, Suwon-si (KR); Sangbum KIM, Suwon-si (KR); Jaehyuk JANG, Suwon-si (KR)

(21) Appl. No.: 18/777,374

(22) Filed: Jul. 18, 2024

(30) Foreign Application Priority Data
Jul. 21, 2023 (KR) 10-2023-0095628

(51) Int. Cl. H04W 36/00; H04W 36/08; H04W 36/32; H04W 88/08

(52) U.S. Cl. CPC H04W 36/00725; H04W 36/0058; H04W 36/085; H04W 36/324; H04W 88/085

(57) ABSTRACT

The disclosure relates to a 5G or 6G communication system for supporting a higher data transmission rate. According to one embodiment, a method for operating a user equipment (UE) in a wireless communication system may comprise receiving an L1/L2 triggered mobility (LTM) medium access control control element (MAC CE) from a base station, determining whether the LTM MAC CE includes a timing advance (TA) value or a random access channel (RACH)-less handover indicator, and when the LTM MAC CE includes the TA value or the RACH-less handover indicator, performing a handover procedure to a target cell based on the TA value or the RACH-less handover indicator.

### CROSS-REFERENCE TO RELATED APPLICATION

This application is based on and claims priority under 35 U.S.C. § 119 to Korean Patent Application No. 10-2023-0095628, which was filed in the Korean Intellectual Property Office on Jul. 21, 2023, the entire disclosure of which is incorporated herein by reference.

### BACKGROUND

### 1. Field

The disclosure relates to a method for operating an uplink time adjustment timer during L1/L2-based handover in a mobile communication system.

### 2. Description of Related Art

5G mobile communication technology defines a wide frequency band to enable fast transmission speed and new services and may be implemented in frequencies below 6 GHz (‘sub 6 GHz’), such as 3.5 GHz, as well as in ultra-high frequency bands (‘above 6 GHz’), such as 28 GHz and 39 GHz called millimeter wave (mmWave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step RACH for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

### SUMMARY

According to the disclosure, when a UE is currently receiving a service from a serving cell through a specific beam, the UE measures and reports a beam belonging to another cell and, if the beam of the neighboring cell becomes better, it may perform a cell change to the corresponding cell.

The disclosure proposes a method for reducing a delay time during a cell change procedure and, particularly, addresses detailed operations related to the operation of performing uplink synchronization on the target cell to reduce the delay time of handover and the operation of performing uplink synchronization on candidate cells in advance to resolve delay due to random access.

According to one embodiment, a method for operating a user equipment (UE) in a wireless communication system may comprise receiving an L1/L2 triggered mobility (LTM) medium access control control element (MAC CE) from a base station, determining whether the LTM MAC CE includes a timing advance (TA) value or a random access channel (RACH)-less handover indicator, and when the LTM MAC CE includes the TA value or the RACH-less handover indicator, performing a handover procedure to a target cell based on the TA value or the RACH-less handover indicator.

According to another embodiment, a method for operating a base station in a wireless communication system may comprise generating an L1/L2 triggered mobility (LTM) medium access control control element (MAC CE), and transmitting the LTM MAC CE to a user equipment (UE). When the LTM MAC CE includes a timing advance (TA) value or a random access channel (RACH)-less handover indicator, a handover procedure to a target cell may be performed by the UE based on the TA value or the RACH-less handover indicator.

According to yet another embodiment, a user equipment (UE) in a wireless communication system may comprise a transceiver and a controller. The controller may be configured to receive an L1/L2 triggered mobility (LTM) medium access control control element (MAC CE) from a base station, determine whether the LTM MAC CE includes a timing advance (TA) value or a random access channel (RACH)-less handover indicator, and when the LTM MAC CE includes the TA value or the RACH-less handover indicator, perform a handover procedure to a target cell based on the TA value or the RACH-less handover indicator.

According to yet another embodiment, a base station in a wireless communication system may comprise a transceiver and a controller. The controller may be configured to generate an L1/L2 triggered mobility (LTM) medium access control control element (MAC CE), and transmit the LTM MAC CE to a user equipment (UE). When the LTM MAC CE includes a timing advance (TA) value or a random access channel (RACH)-less handover indicator, a handover procedure to a target cell may be performed by the UE based on the TA value or the RACH-less handover indicator.

Embodiments of the disclosure propose a method for performing uplink synchronization in advance on the target cell from the time when the UE receives a configuration for the corresponding cell to a time before receiving a handover indication, as a method for performing uplink synchronization on the target cell before a handover indication. Thus, when a handover indication is actually performed on the target cell, it is possible to reduce the delay time required for handover by refraining from performing random access and the operation of performing uplink synchronization and to enable data transmission/reception after a beam change simultaneously with handover to another cell.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a view of a structure of a next-generation mobile communication system to which the present disclosure may be applied;

FIG. 2 illustrates a view of a wireless protocol structure of a next-generation mobile communication system to which the present disclosure may be applied;

FIG. 3 illustrates a view of a structure of another next-generation mobile communication system to which the present disclosure may be applied;

FIG. 4 illustrates a view of an example of inter-cell beam management related to the present disclosure, in which a UE transmits/receives data through a beam of a TRP of a neighboring cell supporting beam change based on L1/L2 while maintaining a connection state with a serving cell;

FIGS. 5A and 5B each illustrate an example in which a UE transmits/receives data by changing a serving cell and a beam to a TRP of a cell supporting L1/L2-based beam change, according to an embodiment of the present disclosure;

FIGS. 6A and 6B illustrate views of an entire operation of performing an L1/L2 inter-cell handover after performing uplink synchronization before performing an L1/L2 inter-cell handover according to an embodiment of the present disclosure;

FIG. 7 illustrates a view of a UE operation for an uplink synchronization timer for a candidate target cell in an entire UE operation of performing an L1/L2 inter-cell handover, which may be applied to embodiments of the present disclosure;

FIG. 8 illustrates a view of a base station operation applied to embodiments of the present disclosure;

FIG. 9 illustrates a block diagram of an internal structure of a UE according to an embodiment of the present disclosure; and

FIG. 10 illustrates a block diagram of a configuration of a base station according to an embodiment of the present disclosure.

### DETAILED DESCRIPTION

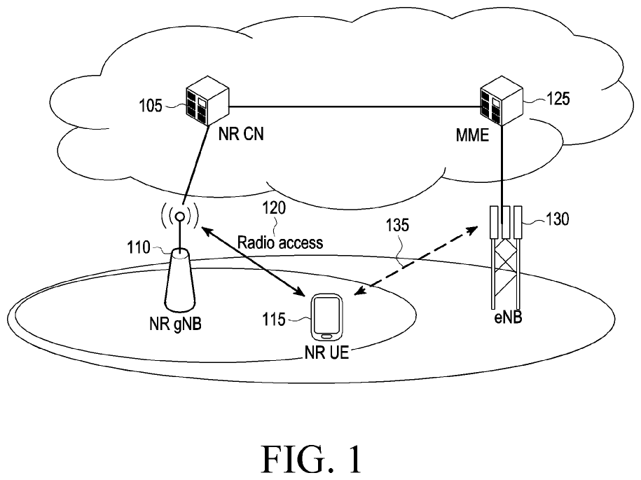

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure is described below with reference to the accompanying drawings. When determined to make the subject matter of the disclosure unclear, the detailed description of known functions or configurations may be skipped. The terms as used herein are defined considering the functions in the disclosure and may be replaced with other terms according to the intention or practice of the user or operator. Therefore, the terms should be defined based on the overall disclosure. As used herein, terms for identifying access nodes, terms denoting network entities, terms denoting messages, terms denoting inter-network entity interfaces, and terms denoting various pieces of identification information are provided as an example for ease of description. Thus, the disclosure is not limited by the terms, and such terms may be replaced with other terms denoting objects with equivalent technical concept.

For ease of description, hereinafter, some of the terms and names defined in the 3rd generation partnership project long term evolution (3GPP LTE) standards may be used. However, the disclosure is not limited by such terms and names and may be likewise applicable to systems conforming to other standards.

Further, in the disclosure, L1/L2-based mobility support is used interchangeably with L1/L2 handover, L1/L2 triggered mobility (LTM), L1/L2 triggered mobility, and the like.

FIG. 1 illustrates a view of a structure of a next-generation mobile communication system to which the present disclosure may be applied.

Referring to FIG. 1, a radio access network of a next-generation mobile communication system may include a next-generation base station (new radio node B, hereinafter, NR NB 110) and a new radio core network (NR CN, or next generation core network (NG CN) 105). A new radio user equipment (hereinafter, NR UE or UE 115) may access an external network through the NR NB 110 and the NR CN 105.

In FIG. 1, the NR NB 110 corresponds to an evolved node B (eNB) of a legacy LTE system. The NR NB 110 may be connected to the NR UE 115 through a radio channel and may provide a service superior to the conventional node B. In the next generation mobile communication system, because all user traffic is serviced through a shared channel, a device is required to collect and schedule state information such as the buffer state, the available transmission power state, the channel state, and the like of UEs, and the NR NB 110 may be responsible for this. One NR NB 110 may control a plurality of cells. In order to implement high-speed data transmission compared to LTE, beamforming technology may be added that may have a bandwidth of the conventional maximum bandwidth or more and uses orthogonal frequency division multiplexing (hereinafter, “OFDM”) as radio access technology. Further, an adaptive modulation & coding (AMC) scheme for determining a modulation scheme and a channel coding rate according to the channel state of the NR UE 115 may be applied.

The NR CN 105 performs functions such as mobility support, bearer configuration, and QoS establishment. The NR CN 105 is the device responsible for various control functions as well as the mobility management function for the NR UE 115, and may be connected to a plurality of base stations. Further, the next generation mobile communication system may interact with the legacy LTE system, and the NR CN 105 is connected to the MME 125 through a network interface. The MME 125 may be connected to the eNB 130, which is a conventional base station.

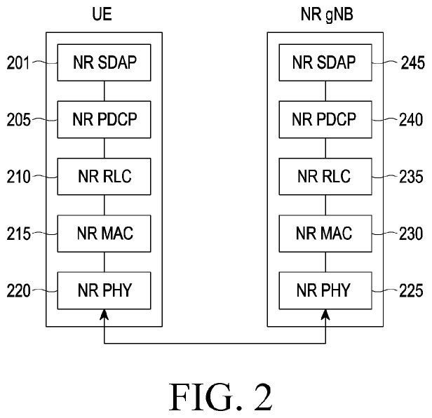

FIG. 2 illustrates a view of a wireless protocol structure of a next-generation mobile communication system to which the present disclosure may be applied.

Referring to FIG. 2, a wireless protocol of a next-generation mobile communication system may include NR SDAPs 201 and 245, NR PDCPs 205 and 240, NR RLCs 210 and 235, and NR MACs 215 and 230, respectively, in a UE and an NR base station (NR gNB).

The main functions of the NR SDAPs 201 and 245 may include some of the following functions.
Transfer of user plane data
Mapping between a QoS flow and a DRB for both DL and UL
marking QoS flow ID in both DL and UL packets
reflective QoS flow to DRB mapping for the UL SDAP PDUs

For the SDAP layer device, the UE may be set, via an RRC message, for whether to use the functions of the SDAP layer or the header of the SDAP layer device per PDCP layer device, per bearer, or per logical channel. If an SDAP header has been set, the UE may be instructed to update or reset mapping information for the data bearer and QoS flow of uplink and downlink, by a one-bit NAS reflective QoS indicator and a one-bit AS reflective QoS indicator. The SDAP header may include QoS flow ID information indicating QoS. The QoS information may be used as data priority handling or scheduling information for seamlessly supporting a service.

The main functions of the NR PDCPs 205 and 240 may include some of the following functions.
Header compression and decompression (ROHC only)
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering by the NR PDCP refers to reordering PDCP PDUs received by the lower layer based on the PDCP sequence numbers (SNs) and may include transferring the data to the higher layer in the reordered sequence or immediately without considering order, recording PDCP PDUs missed by reordering, reporting the state of the missing PDCP PDUs to the transmit part, and requesting to retransmit the missing PDCP PDUs.

The main functions of the NR RLCs 210 and 235 may include some of the following functions.
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery by the NR RLC device refers to transferring the RLC SDUs received from the lower layer to the higher layer in order and, if one original RLC SDU is split into several RLC SDUs that are then received, the in-sequence delivery may include reassembling and transferring them, reordering the received RLC PDUs based on the RLC SNs or PDCP SNs, recording the RLC PDUs missed by reordering, reporting the state of the missing RLC PDUs to the transmit part, and requesting to retransmit the missing RLC PDUs and, if there are missing RLC SDUs, the in-sequence delivery may include transferring only RLC SDUs before the missing RLC SDUs to the higher layer in order. Although there are missing RLC SDUs, if a predetermined timer has expired, the in-sequence delivery may include transferring all of the RLC SDUs received before the timer starts to the higher layer in order. Or, although there are missing RLC SDUs, if the predetermined timer has expired, the in-sequence delivery may include transferring all of the RLC SDUs received thus far to the higher layer in order.

Further, the RLC PDUs may be processed in order of reception (in order of arrival regardless of the sequence number order) and delivered to the PDCP device regardless of order (out-of-sequence delivery). For segments, segments which are stored in a buffer or are to be received later may be received and reconstructed into a single whole RLC PDU, and then, the whole RLC PDU is processed and transferred to the PDCP device. The NR RLC layer may not include the concatenation function, and the function may be performed by the NR MAC layer or replaced with a multiplexing function of the NR MAC layer.

The out-of-sequence delivery by the NR RLC device refers to immediately transferring the RLC SDUs received from the lower layer to the higher layer regardless of order and, if one RLC SDU is split into several RLC SDUs that are then received, the out-of-sequence delivery may include reassembling and transferring them and storing the RLC SNs or PDCP SNs of the received RLC PDUs, ordering them, and recording missing RLC PDUs.

The NR MACs 215 and 230 may be connected to several NR RLC layer devices configured in one UE, and the functions of the NR MAC may include some of the following functions.
Mapping between logical channels and transport channels
Multiplexing/demultiplexing of MAC SDUs
scheduling information reporting
Error correction through hybrid automatic repeat request (HARQ)
Priority handling between logical channels of one UE
Priority handling between UEs by means of dynamic scheduling
MBMS service identification
Transport format selection
Padding

The NR PHY layers 220 and 225 may channel-code and modulate higher layer data into OFDM symbols, transmit the OFDM symbols through a wireless channel or demodulates OFDM symbols received through a wireless channel, channel-decodes and transfers the same to a higher layer.

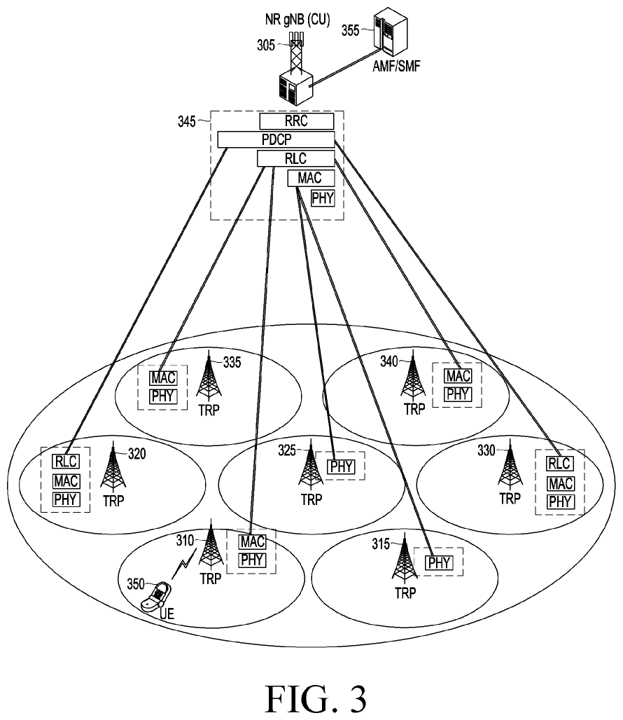

FIG. 3 illustrates a view of a structure of another next-generation mobile communication system to which the present disclosure may be applied.

Referring to FIG. 3, a cell serviced by the NR gNB 305 operating based on a beam may include several transmission reception points (TRPs) 310, 315, 320, 325, 330, 335, and 340. The TRPs 310 to 340 represent blocks obtained by separating some functions of transmitting and receiving a physical signal from a conventional NR base station (eNB), and may be composed of a plurality of antennas. The NR gNB 305 may be expressed as a central unit (CU), and the TRP may also be expressed as a distributed unit (DU). Functions of the NR gNB 305 and the TRPs 310 to 340 may be configured by separating each layer from the PDCP/RLC/MAC/PHY layers such as 345. According to one embodiment, the TRP may have only the PHY layer and perform the function of the corresponding layer (315, 325), the TRP may have only the PHY layer and the MAC layer and perform the functions of the corresponding layers (310, 335, 340), and the TRP may have only the PHY layer, the MAC layer, and the RLC layer and perform the functions of the corresponding layers (320, 330). The TRPs 310 to 340 may use a beamforming technology for transmitting/receiving data by generating narrow beams in various directions using a plurality of transmission/reception antennas. The UE 350 accesses the NR gNB 305 and an external network through the TRPs 310 to 340. In order to serve users, the NR gNB 305 may collect and schedule state information such as the buffer state, the available transmission power state, the channel state, and the like of UEs to support connection between the UEs and the core network (CN), in particular, the AMF/SMF 355.

In the disclosure, the TRP is based on structures 315 and 325 that have only the PHY layer and may perform the function of the corresponding layer.

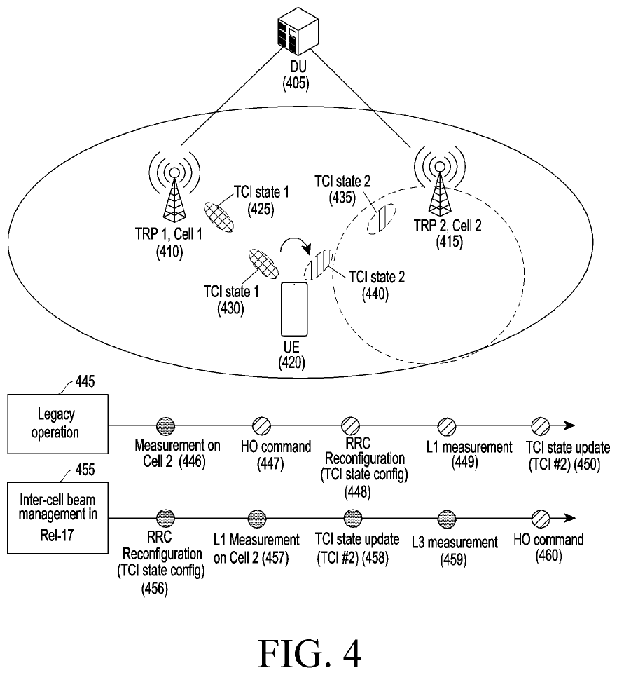

FIG. 4 illustrates a view of an example of inter-cell beam management related to the present disclosure, in which a UE transmits/receives data through a beam of a TRP of a neighboring cell supporting beam change based on L1/L2 while maintaining a connection state with a serving cell.

Although FIG. 4 illustrates a case in which a plurality of cells TRP 1-Cell 1 410 and TRP 2-Cell 2 415 are present in one distributed unit 405 (DU), the overall content of the disclosure may also be applied to inter-DU case (each DU constitutes one TRP-Cell). In the disclosure, a cell (TRP 2, Cell 2) which is not a serving cell supporting L1/L2-based mobility (beam change and serving cell change) is interchangeably referred to as a neighbor cell, a non-serving cell, or an additional cell with the PCI different from the serving cell.

In the conventional UE beam change procedure 445, the UE 420 may transmit/receive data in a connected state through TRP 1 410 of the serving cell 1, and may be adjusted to TCI state 1 425 or 430 which is the optimal beam. In this step, the UE may receive, from the serving cell 410, an indication of configuration information for L3 channel measurement (radio resource management (RRM)) for the additional cell (TRP 2-Cell 2 415) with the different PCI from the serving cell through RRC configuration information and perform an L3 measurement operation 446 on the corresponding frequency and cell. Thereafter, the serving cell (TRP 1-Cell 1 410) may indicate (447) a handover to the corresponding cell (TRP 2-Cell 2 415) based on the reported measurement value, and the handover may be completed, and additional RRC configuration information may be transferred (448) to the UE 420 through TRP 2-Cell 2 415.

The RRC configuration information may include at least one of UL/DL configuration information in the corresponding cell and L1 measurement-related configuration (CSI-RS measurement and reporting), and may include TCI state configuration information for the physical downlink control channel (PDCCH) and the physical downlink shared channel (PDSCH) channel. The UE 420 may perform L1 measurement according to configuration (449), and the base station may update the TCI state through L1/L2 signaling according to the measurement report (450). Here, TCI state 2 440, which is an optimal beam, may be indicated. In this step, until the handover, the serving cell is Cell 1 and, after the handover, Cell 2 becomes the serving cell. In other words, many procedures and times are required even after handover until the optimal beam is indicated.

Unlike the conventional UE beam change procedure 445, an enhanced beam change scheme 455 considered in the disclosure is as follows. The UE 420 may refer to, and transfer, in the serving cell, the beam configuration associated with the cell (TRP 2-Cell 2 415) with the different PCI from the serving cell through the RRC configuration information 456 from the serving cell 410. The beam configuration associated with the additional cell (TRP 2-Cell 2 415) with the different PCI from the serving cell, i.e., the part of associating the TCI state corresponding to TRP2, may adopt a method for indicating by associating a new cell ID (Physical cell ID PCI, additional PCI-r17) as follows.

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| | | |
|---|---|---|
| additionalPCI-r17 | AdditionalPCIIndex-r17 | OPTIONAL, -- |

Need R

| | |
|---|---|
| pathlossReferenceRS-Id-r17 | PUSCH-PathlossReferenceRS-Id |

OPTIONAL, -- Cond JointTCI

| | | |
|---|---|---|
| ul-powerControl-r17 | Uplink-powerControlId-r17 | OPTIONAL -- |

Cond JointTCI
]]
}

Further, a unified TCI state framework is applied for beam management entity between the corresponding cells. The unified TCI state framework may be set as one of a joint UL/DL mode and a separate UL/DL mode as applying a common TCI state framework in uplink and downlink, and a common channel and a dedicated channel.

MIMOParam-r17 ::= SEQUENCE {

| | |
|---|---|
| additionalPCI-ToAddModList-r17 | SEQUENCE (SIZE(1..maxNrofAdditionalPCI-r17)) |
| OF SSB-MTC-AdditionalPCI-r17 | OPTIONAL, -- Need N |
| additionalPCI-ToReleaseList-r17 | SEQUENCE (SIZE(1..maxNrofAdditionalPCI-r17)) OF |
| AdditionalPCIIndex-r17 | OPTIONAL, -- Need N |
| unifiedTCI-StateType-r17 | ENUMERATED {separate, joint} |

OPTIONAL, -- Need R
uplink-PowerControlToAddModList-r17 SEQUENCE (SIZE (1..maxUL-TCI-r17)) OF

| | |
|---|---|
| Uplink-powerControl-r17 | OPTIONAL, -- Need N |

uplink-PowerControlToReleaseList-r17 SEQUENCE (SIZE (1..maxUL-TCI-r17)) OF

| | |
|---|---|
| Uplink-powerControlId-r17 | OPTIONAL, -- Need N |
| sfnSchemePDCCH-r17 | ENUMERATED {sfnSchemeA,sfnSchemeB} |

OPTIONAL, -- Need R

| | |
|---|---|
| sfnSchemePDSCH-r17 | ENUMERATED {sfnSchemeA,sfnSchemeB} |

OPTIONAL -- Need R
}

1. Joint UL/DL mode: Configure UL and DL to share the same TCI configuration (in PDSCH-Config)

| | |
|---|---|
| dl-OrJoint-TCIStateList-r17 | CHOICE { |
| explicitlist | SEQUENCE { |
| dl-orJoint-TCI-State-ToAddModList-r17 | SEQUENCE (SIZE (1.. maxNrofTCI- |

States)) OF TCI-State

| | |
|---|---|
| | OPTIONAL, -- Need N |
| dl-orJoint-TCI-State-ToReleaseList-r17 | SEQUENCE (SIZE (1.. maxNrofTCI- |

States)) OF TCI-StateId

OPTIONAL -- Need N

},

| | |
|---|---|
| unifiedTCI-StateRef-r17 | ServingCellAndBWP-Id-r17 |
| } | OPTIONAL, -- Need R |

2. Separate UL/DL mode: UL and DL provide their respective TCI configurations. The TCI state for DL follows the configuration in dl-OrJoint-TCIStateList-r17 (in PDSCH-Config), and the TCI state for UL follows ul-TCI-StateList-r17 (in BWP-UplinkDedicated).

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF TCI-UL- |
| State-r17 | OPTIONAL, -- Need N |
| ul-TCI-ToReleaseList-r17 | SEQUENCE (SIZE (1..maxUL-TCI-r17)) OF TCI-UL- |
| State-Id-r17 | OPTIONAL -- Need N |

},

| | |
|---|---|
| unifiedTCI-StateRef-r17 | ServingCellAndBWP-Id-r17 |
| } | OPTIONAL, -- Need R |

After the configuration for the TRP 2-Cell 2 is provided in the RRC connected state to serving cell 1, the UE 420 may perform the L1 measurement on the corresponding TRP 2-Cell 2 according to the configuration and report the corresponding result to the serving cell (Cell 1 410) (457). When it is determined that a change to a specific beam TCI state 2 435 or 440) of TRP 2 (Cell 2 415), rather than the serving cell beam (TCI state 1 425 or 430) is required according to the measurement result, the serving cell may trigger a beam change and indicate it to the UE 420 through L1/L2 signaling (458). The UE 420 may change the beam to a specific beam (TCI state 2, 440) of TRP 2 (Cell 2, 415) through the corresponding indication, and perform a physical channel establishment and higher layer establishment operation associated with the configured beam. From this step, although the UE 420 is connected to the serving cell (Cells 1 410), the UE 420 may perform data transmission/reception using the channel link of TRP 2 (Cells 2 415) (PDCCH/PDSCH reception, physical uplink control channel (PUCCH)/physical uplink shared channel (PUSCH) transmission). In other words, transmission/reception of the common control channel is performed through the serving cell (Cells 1 410).

Thereafter, the UE 420 may perform the L3 measurement operation according to the measurement configuration configured in the independent serving cell (459), receive a handover command message from the serving base station Cell 1, and change the serving cell to Cell 2 (460). Through the present scheme 455, the UE 420 may perform data transmission/reception with a specific TRP 2 of Cell 2 supporting L1/L2-based mobility in a state of being connected to the serving cell, and may continuously use the corresponding beam even after handover.

For reference, the RRC configuration for the configuration and operation related to the L1 measurement and report in step 457 is described below. This content is basically applied to the following embodiments of the disclosure, and an enhancement scheme may be added in the following embodiments.
1. CSI measurement configuration (LTM CSI resource configuration)
CSI-RS resource and resource pool applied to all LTM candidate cells requiring measurement considering continuous LTM support
CSI-RS resource configuration (aperiodic, semi-persistent) and triggering configuration requiring measurement
When CSI-RS resource refers to the SSB resource, provides additional PCI information to enable L1 measurement from the neighbor cell (up to seven neighbor cells (PCI) may be added in one serving cell)
A plurality of CSI resource configurations may be configured in the form of an add/mod/release list, as a separate configuration in the LTM configuration (LTM-Config)
Cell index, etc., may be marked to identify the CSI resource configured in a specific candidate cell
2. CSI report configuration (LTM CSI report configuration)
CSI report configurations respectively applied to the current serving cell and each candidate cell configuration may be provided considering continuous LTM support (for reference, the principle in which the corresponding configuration is present in the cell where CSI reporting is performed)
Information for interacting with the LTM CSI resource configuration may be included
Report type: periodic report, semi-periodic report on PUCCH, semi-periodic report on PUSCH, aperiodic report on PUSCH (periodic, semi-persistent for PUCCH, semi-persistent for PUSCH, aperiodic)
Report quantity
Other configurations required for reporting

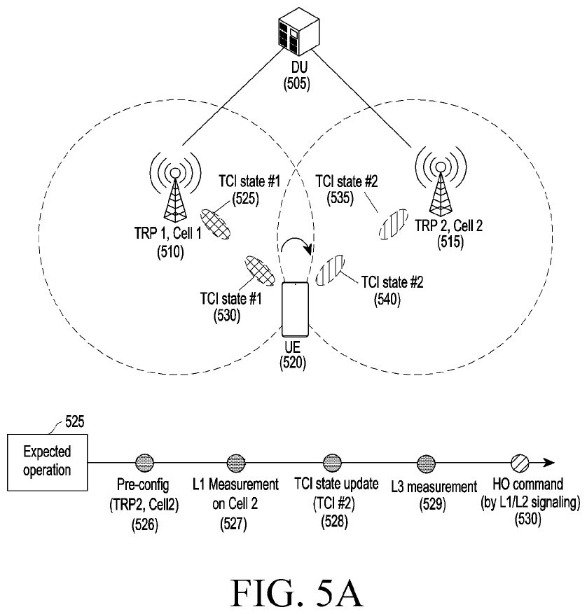

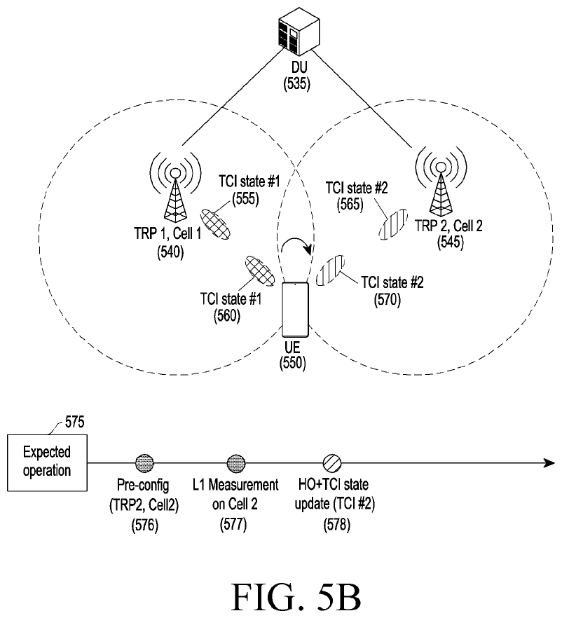

FIG. 5A illustrates an example in which a UE transmits/receives data by changing a serving cell and a beam to a TRP of a cell supporting L1/L2-based beam change, according to an embodiment of the present disclosure.

Although FIGS. 5A and 5B illustrate a case in which a plurality of cells TRP 1-Cell 1 and TRP 2-Cell 2, 510, 515, 540, and 545 are present in one distributed unit (DU) 505 or 535, the overall content of the disclosure may also be applied to inter-DU case (each DU constitutes one TRP-Cell).

Unlike the conventional UE beam change procedure 445 or 455 described in FIG. 4, the enhanced beam change scheme 525 or 575 considered in the present embodiments is as follows.
1. Embodiment 1 (525 of FIG. 5A): Perform L1/L2 handover after performing inter-cell beam management (change) operation
2. Embodiment 2 (575 of FIG. 5B): Perform L1/L2 handover immediately

The overall operation of embodiment 1 shown in FIG. 5A is described. The UE 520 may receive common configuration and dedicated configuration information about the additional cell (TRP 2-Cell 2 515) with the different PCI from the serving cell through RRC configuration information from the serving cell 510. In other words, configuration information corresponding to ServingCellConfigCommon and ServingCellConfig, ServingCellID or candidateCellID (cell ID associated with the PCI), may be provided in advance. The corresponding configuration information may be provided in the form of pre-configuration in RRC configuration, and configuration information for a plurality of cells may be included. Further, the corresponding configuration includes all configuration information (cell configuration, bearer configuration, security key configuration, etc.) applied when the UE moves to the corresponding cell (handover). Further, the corresponding configuration may include the unified TCI state configuration described in step 456 of FIG. 4 and configurations related to the L1 measurement and report. The embodiment in the present figure deals with a specific method for a structure for previously providing a configuration for candidate neighbor cells where L1/L2 handover may be performed, an operation in which the corresponding configuration is optionally applied after handover in L1/L2 signaling, and an L1/L2 beam change and cell change (handover).

In the RRC connected state to serving cell 1, after a configuration for TRP 2-Cell 2 515 is provided, the UE 520 performs L1 measurement on the corresponding TRP 2-Cell 2 515 according to the configuration received in step 527 and reports the result to the serving cell (Cell 1 510). When it is determined that a change to a specific beam (TCI state 2 540) of TRP 2 (Cell 2 515), rather than the serving cell beam (TCI state 1 525), is required according to the measurement result, the serving cell may trigger a beam change in step 528 and indicate to the UE 520 through L1/L2 signaling. The UE 520 may perform beam change to TRP 2 (Cell 2 515) through the corresponding indication and transmit/receive data through the corresponding TRP 2 (Cell 2 515). In this case, the serving cell is not changed, and the UE 520 may still be RRC connected to the serving cell (Cell 1 510). Thereafter, the UE 520 still performs the L1 measurement on the TRP 2-Cell 2 515 and reports the result to the serving cell (Cell 1 510). The serving cell (Cell 1 510) may indicate handover to the UE 520 when the L1 measurement reported by the UE meets a triggering condition (detailed operation is described below) for the handover to the TRP 2-Cell 2 515. The indication may be an L1/L2 message. In other words, an indicator indicating handover may be included in the MAC CE or DCI.

Embodiment 2 of the disclosure is characterized by an operation of performing uplink synchronization on the target cell before the UE 520 receives a handover message through the target cell to perform handover particularly in the above-described situation. A detailed method is described in connection with embodiment 2.

In the entire operation of the embodiment 2 illustrated in FIG. 5B, the UE 520 may receive common configuration and dedicated configuration information for the LTM candidate cell (TRP 2-Cell 2 545) from the serving cell 540 through RRC configuration information (576). In other words, configuration information corresponding to ServingCellConfigCommon and ServingCellConfig, ServingCellID or candidateCellID (cell ID associated with the PCI), may be provided in advance. The corresponding configuration information may be provided in the form of pre-configuration in RRC configuration, and configuration information for a plurality of cells may be included. Further, the corresponding configuration includes all configuration information (cell configuration, bearer configuration, security key configuration, etc.) applied when the UE 520 moves to the corresponding cell (handover). Further, the corresponding configuration may include the unified TCI state configuration described in step 456 of FIG. 4 and configurations related to the L1 measurement and report. Embodiment 2 of the disclosure is characterized by an operation of performing uplink synchronization on the target cell before the UE receives a handover message through the target cell to perform handover particularly in the above-described situation. The detailed method is described in the following embodiment.

In the RRC connected state to serving cell 1, after a configuration for TRP 2-Cell 2 545 is provided, the UE performs L1 measurement on the corresponding TRP 2-Cell 2 545 according to the configuration received in step 577 and reports the result to the serving cell (Cell 1 540). When it is determined that handover is required simultaneously with a change to a specific beam (TCI state 2 570) of TRP 2 (Cell 2 545), rather than the serving cell beam (TCI state 1 545) according to the measurement result, the serving cell may trigger a beam change and handover in step 578 and indicate to the UE through L1/L2 signaling. The UE 520 may perform handover simultaneously with beam change to TRP 2 (Cell 2 515) through the corresponding indication and transmit/receive data through the corresponding TRP 2 (Cell 2 515). In this case, the UE 520 applies the configuration information for the target cell where handover is performed, as preset in step 576. Depending on whether uplink synchronization is required in the corresponding step, the UE 520 may perform random access or may omit random access to the target cell. A detailed operation is described with reference to the accompanying drawings.

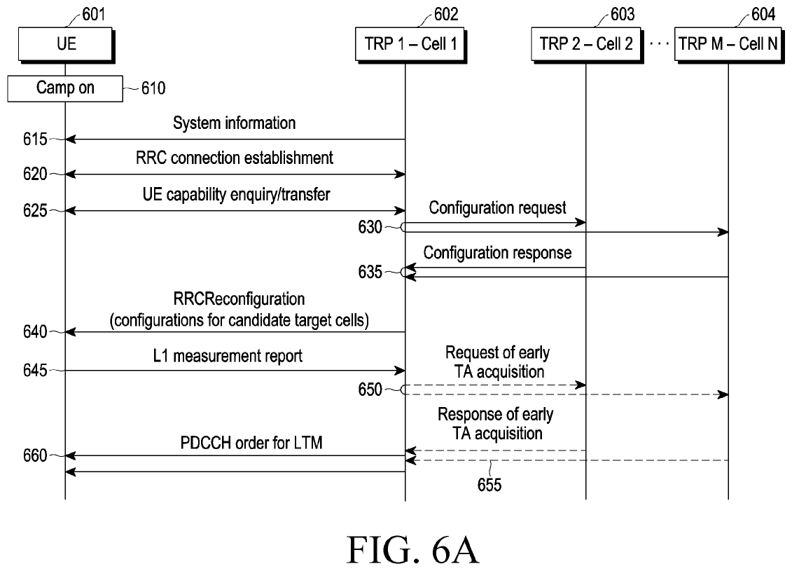

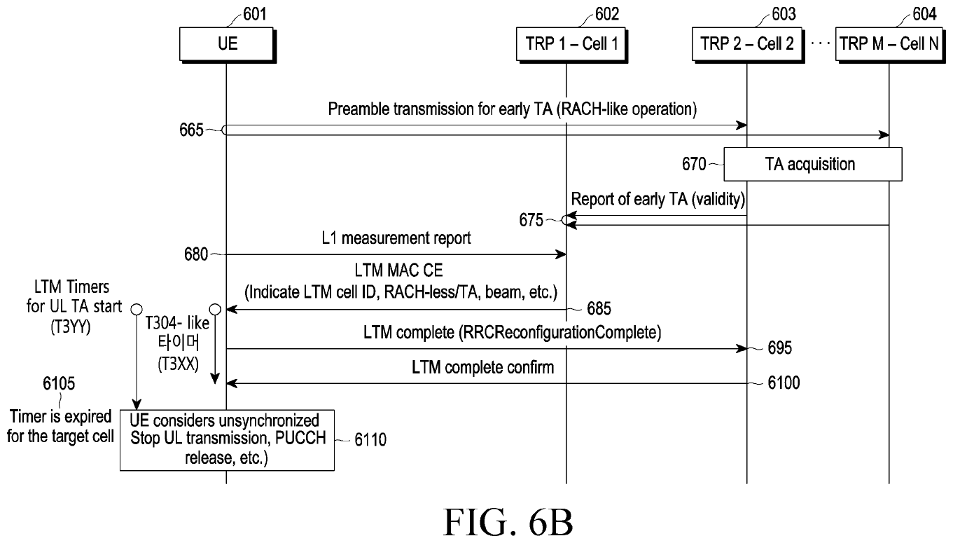

FIGS. 6A and 6B illustrate views of an entire operation of performing an L1/L2 inter-cell handover after performing uplink synchronization before performing an L1/L2 inter-cell handover according to an embodiment of the present disclosure.

In one embodiment, an operation of performing uplink synchronization with a target cell before receiving a handover indicator and a detailed operation of an uplink synchronization-related timer applied after performing LTM are described.

The UE 601 may receive system information from the serving cell (TRP 1-Cell 1) 602 in the camp-on state 610 (615) and perform a transition procedure to the connected state (620). Thereafter, the serving cell 602 may request a UE capability (UE capability enquiry message) from the UE 601, and the UE 601 may receive and transfer the UE capability (UE capability information message) according to a request of base station request (625). The corresponding UE capability may include whether to support L1/L2-based inter-cell beam change/management and handover, and the UE capability may also include a capability related to whether to support an operation of previously performing uplink synchronization for candidate target cells before handover. The UE transfers the corresponding UE capability through signaling of at least one of UE-specific capability, band-specific capability, or band combination-specific capability.

The serving cell 602 may request (630) configuration information required when the UE 601 performs a beam change and handover based on L1/L2 from the neighbor cells (TRP 2-Cell 2, TRP M-Cell N) 603 and 604 that support L1/L2-based mobility, and the neighbor cells 603 and 604 may include related configuration information in a response message to the corresponding request and transfer (635) the same. The procedures 630 and 635 may be used to request and transfer pre-configuration related configurations of cells related to L1/L2 inter-cell beam change and handover (LTM) through an inter-node RRC message or an Xn, F1 interface, or the like. When the first cell 602 and the neighbor cells 603 and 604 are present in one DU in a network implementation (intra-DU scenario), it may be omitted in the implementation. When inter-cell beam change and handover are indicated by L1/L2-based signaling, a configuration for the cell where preset handover is indicated is applied to the UE 601. In step 640, an RRC structure for supporting L1/L2 inter-cell beam change (management entity) and handover operation, in particular pre-configuration for candidate neighbor cells, is provided, and may be the structure described in connection with FIGS. 4, 5A, and 5B.

In step 640, the serving cell 602 may transfer common/dedicated configuration information applied after the L1/L2-based movement (beam change and handover) to the neighbor cells 603 and 604 is indicated to the UE 601. Since the UE 601 should transfer all the configurations of the corresponding cell applied after the handover in advance, the common/dedicated configuration information may include at least one of ServingCellID or candidateCellID (cell ID associated with PCI), configuration information corresponding to ServingCellConfigCommon and ServingCellConfig, or configuration for the cell group (MAC, RLC, etc.). The corresponding configuration information may be provided in the form of pre-configuration in RRC configuration, and may include configuration information for a plurality of cells and cell groups. Further, the corresponding configuration may include all configuration information (cell configuration, bearer configuration, security key configuration, measurement configuration etc.) applied when the UE 601 moves to the corresponding cell (handover). The corresponding configuration may include the unified TCI state configuration described in step 456 of FIG. 4 and configurations related to the L1 measurement and report for the LTM candidate cells.

In addition to the RRC configuration information for the basic candidate target cells, the present embodiment may provide a configuration related to performing uplink synchronization for the candidate target cells before handover.

In the following embodiments of the disclosure, terms such as early timing advance (TA), early RACH, or pre-acquisition of uplink synchronization or pre-random access are used interchangeably. Further, the corresponding configuration may be composed of the following values. In the disclosure, the term “early TA” is used, but this may be early random access or an operation of performing uplink synchronization similar to early random access. As is described in detail below, the early TA operation may be defined as an operation of transmitting preset contention-based random access (CBRA) or contention-free random access (CFRA) preamble for each LTM candidate cell, and msg1 transmission. According to one embodiment, a random access response (RAR) (msg2) may be received in response to the msg1 signal. The RAR signal may follow an conventional RAR signal or may be a modified RAR.
Method for configuring early TA operation for LTM candidate target cells
Provides contention-based random access (CBRA) and contention-free random access (CFRA) preamble configuration (one or more preamble indexes/PO indexes/SSB indexes) required for early TA for each LTM candidate cell
In other words, common RACH resource or dedicated RACH resource may be configured and used for each LTM candidate cell. The corresponding configuration may be provided from the source cell as an LTM configuration, or may be included in the candidate cell configuration.

In step 645, the UE 601 may perform measurement on the L1 measurement resource for the LTM according to the RRC configuration received in step 640, and may report the measurement result to the base station (serving cell 602). The L1 measurement report may be a measurement value for LTM candidate cells, and is performed according to a scheme (periodic report, aperiodic report, one-time report) set by the base station.

In steps 650 and 655, the serving cell 602 may notify the LTM candidate cells 603 and 604 that the LTM configuration has been transferred to the UE 601, while requesting and receiving a response as to whether to perform early TA. Each of the LTM candidate cells may determine whether the TA with the UE 601 is valid, whether to perform the RACH-less handover, or the like. Steps 650 and 655 may be omitted, and in this case, the source cell 602 may determine whether to perform early TA without a separate request and response procedure, and may indicate the same the UE 601.

In step 660, the source cell 602 may transfer the PDCCH order to the UE 601 according to the determination of the need for the early TA to the specific LTM candidate cells. The PDCCH order may include an indicator indicating the LTM candidate cell (the LTM candidate cell configuration and index are provided in the RRC configuration and used in the PDCCH order). According to one embodiment, the LTM candidate cell index may be indicated using reserved bits present in DCI format 1_0. Upon receiving the PDCCH order, the UE 601 may perform random access preamble transmission for early TA to LTM candidate cells indicated in the corresponding signal.

A CFRA resource for early TA for LTM candidate cells may be configured in step 640, and the UE 601 may transmit a random access preamble to the LTM candidate cell indicated in the PDCCH order, using the corresponding resource in step 665. According to one embodiment, the early TA procedure may perform only msg1 (random access preamble) transmission but may not receive msg2 (RAR). In the early TA procedure, there may be no operation of receiving the RAR, so that there is no operation in which the UE 601 obtains the TA according to the early TA and manages the TA value according to the timer in the UE 601. In step 670, the LTM candidate cell (target cell where the early TA is performed) calculates the TA value between the UE 601 and the corresponding cell through the RACH preamble received from the UE 601, and internally stores and manages the TA value. Thereafter, in order to determine the validity of the TA value (its own timer or reception of UE measurement value) to re-trigger the early TA, the lack of uplink TA validity for the UE 601 may be transferred to the source cell 602 in step 675. In the above, the internal timer of the base station for determining validity may be internally operated in the source cell and the LTM candidate cell (target cell where the early TA is performed) and, to that end, the timer value may be shared therebetween or may be configured and transferred. Further, instead of the procedures 670/675, the source cell may determine the validity of the TA value (its own timer or reception of UE measurement value) to re-trigger the early TA. An inter-node procedure for early TA between the source cell and the LTM candidate cells is summarized as follows.
Option 1: Manages the validity of the TA value for early TA in the LTM candidate cell. In other words, if the early TA value is determined not to be valid, a PDCCH order is requested again from the source cell.
Option 2: The LTM candidate cell transfers a TA valid timer value along with a valid TA value to the source cell. When the corresponding timer expires in the source cell and a new valid TA value is not received again from the corresponding LTM candidate cell, a PDCCH order for early TA for the corresponding LTM candidate cell is newly triggered, or when an LTM operation is to be indicated to the UE, the LTM MAC CE is transferred to indicate handover. In this case, without including a valid TA value (without including an indicator including the TA value or an RACH-less indicator), the UE is indicated to perform random access when performing LTM.

In step 680, the UE 601 may measure the L1 measurement resource according to RRC configuration for the LTM and report the measurement result to the base station (source cell) 602. In step 685, the serving cell 602 may determine a cell change (handover) of the UE based on the received L1 measurement result and indicate handover to the target cell (TRP 2-Cell 2 603) through the MAC CE indicating LTM. The LTM MAC CE includes the following information.
Index (candidate cell ID, candidate cell configuration ID) of the target cell where LTM is performed
Active BWP ID in the target cell
Indicator (one-bit or activated SCell information) indicating whether to perform SCell activation (carrier aggregation) simultaneously with performing LTM
UL grant information (resource for data transmission after LTM in the target cell, e.g., resource used for transmission of RRCReconfigurationComplete message)
Beam information (TCI state, unified TCI state information) used when transmitting in the target cell
C-RNTI used in the target cell
RACH-less handover and uplink TA information-related
Timing Advance Command information: The source cell may transfer a valid TA value to the LTM MAC CE to indicate RACH-less handover to the target cell, to the UE.
Option 1:12-bit TA value like the one included in the conventional RAR
Option 2: Relative TA value and reference cell and TA information
Reference cell and TA information: Unless indicated otherwise, the cell where PTAG applies becomes the reference, and the PTAG value becomes the TA reference value. Or, specific cell or TAG ID may be indicated as the reference cell and reference TA value.
Relative TA value: Relative TA value to the reference TA value for TAG and reference cell (6-bit TA value like the Timing Advance Command in the conventional ‘Timing Advance Command MAC CE’)
Indicator indicating whether TA value is present (or RACH/RACH-less indicator): The corresponding information may be transferred as one bit or may be implicitly indicated through another field. In other words, it may be omitted.
Example 1: If the TA value is provided from the MAC CE, although there is no separate RACH/RACH-less indicator, the UE performs RACH-less handover to the target cell by applying the corresponding TA value. In this case, whether there is a TA value or an indicator indicating whether there is a TA value plays a role as the RACH/RACH-less indicator.
When a TA value is indicated, if it indicates 0 relative to the current reference cell and TAG, the TA value of the corresponding TAG (e.g., PTAG) is applied as it is.
When an absolute TA value is used when the TA value is indicated, the TA value of the current corresponding TAG (e.g., PTAG) is indicated again and transferred.
Example 2: The indicator indicating whether there is a TA value and the RACH/RACH-less indicator may be separately indicated. In this case, the TA value is indicated, but it may be used, e.g., when indicating the RACH.

In step 685, if the UE 601 receives the LTM MAC CE, the UE 601 may hand over the target cell according to the included information, change the beam to the indicated beam, and perform data transmission/reception through the corresponding beam. In this step, whether to perform random access to the target cell (TRP 2-Cell 2 603) omits a random access operation when performing handover to the target cell according to the TA value indicated by the LTM MAC CE and the indicator (RACH-less handover indicator) including the valid TA value and applies uplink synchronization to the corresponding target cell. In the above step, the UE 601 attempts handover to the target cell and simultaneously drives a handover operation timer to the LTM target cell. In this case, a T304 timer, which is a conventional handover operation timer, may be used, or a new timer (e.g., T3XX) dedicated to LTM may be introduced. The corresponding timer configuration may be transferred when the LTM configuration is provided as the RRC configuration, and a timer value may be individually set in each candidate LTM cell configuration (in this case, set in the SpCell configuration of the candidate LTM cell configuration), or may be set to be commonly applied to all LTM candidate cells. If the LTM handover ends while the corresponding T3XX timer is running, the corresponding T3XX timer stops and it is determined that the handover has been completed safely. Here, the case where the LTM handover ends may be a case where the UE 601 transfers a first uplink transmission (RRCReconfigurationComplete message) to the LTM target cell (695) and receives a response to the corresponding message (6100). The response method may be one of the following methods.
Option 1: Reception of RLC ACK of RRCReconfigurationComplete message
Option 2: Reception of C-RNTI addressed PDCCH
Option 3: Reception of UE Contention Resolution identify MAC CE

If the LTM handover is not completed until the corresponding T3XX timer expires, a timer expiration operation for each cell group (MN or SN) is performed. In other words, when the T3XX for the MCG expires, the RRC re-establishment procedure for the MCG is performed, and when the T3XX for the SCG expires, the SCG failure procedure is performed after notifying the network that the LTM failure has occurred in the SCG.

Further, in step 690, when the UE receives a valid TA value for the LTM candidate cell (the LTM MAC CE provides the TA value, or random access to the LTM target cell is performed to obtain the valid TA value), the UE operates a timer (T3YY, a TA validity determination timer applied in the LTM target cell) for determining how long the corresponding TA value is valid in the LTM target cell. The T3YY timer may be configured and provided in the following manner.
Option 1: Provides as a CellGroup level in the LTM candidate cell configuration and applied to the MAC entity including the LTM candidate cell. May be configured as a timer associated with the PTAG of the target cell when operating LTM operation. (in other words, TAG-ID 0 and the T3YY timer value associated therewith are set). The timer may start when the LTM MAC CE is received or when successful LTM handover is completed. (or the timer may start at the moment of receiving and applying a valid uplink tvTA value.)
Option 2: Includes the T3YY timer value in the LTM MAC CE indicating handover to the LTM target cell and transfers the same. The UE applies the received timer, determining that the TA value obtained after LTM handover is valid as long as the time indicated in the corresponding timer. The timer may start when the LTM MAC CE is received or when successful LTM handover is completed. (or the timer may start at the moment of receiving and applying a valid uplink tvTA value.)
Option 3: The T3YY timer is received from the target cell after completing the LTM handover. Or, it may be configured through the MAC CE or an RRC message. When receiving the corresponding configuration, the timer immediately starts.

The valid TA value received through the LTM MAC CE is determined to be valid while the TA timer operates and, if the LTM handover fails while the timer is running, the corresponding timer may be stopped (stop). Further, the timer may be operated equally in the target cell as well, and when the corresponding timer expires (6105), in step 6110, the UE 601 determines that uplink synchronization with the target cell fails, performing an operation, such as the conventional operation when uplink synchronization fails, PUCCH/sounding reference signal (SRS) release, HARQ buffer flush, etc. The following description is referred to.

```
1> when a timeAlignmentTimer expires:
  2> if the timeAlignmentTimer is associated with the PTAG:
    3> flush all HARQ buffers for all Serving Cells;
    3> notify RRC to release PUCCH for all Serving Cells, if configured;
    3> notify RRC to release SRS for all Serving Cells, if configured;
    3> clear any configured downlink assignments and configured uplink
    grants;
    3> clear any PUSCH resource for semi-persistent CSI reporting;
    3> consider all running timeAlignmentTimers as expired;
    3> maintain N_{TA} (defined in TS 38.211 [8]) of all TAGs.
```

For reference, since the target cell is able to know, e.g., expiration of the corresponding T3 YY timer, if necessary, it may again trigger random access to the UE in PDCCH order, performing uplink synchronization of the UE 601.

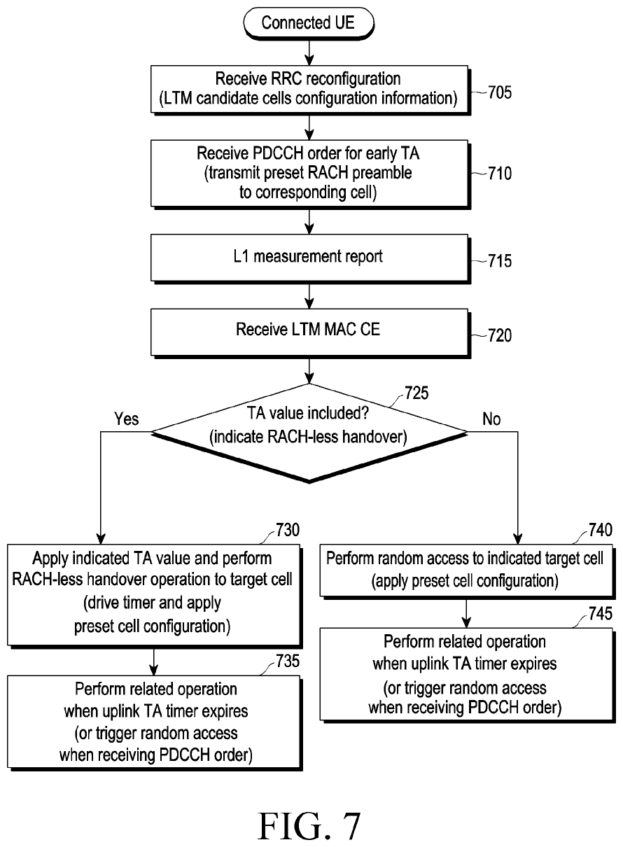

FIG. 7 illustrates a view of a UE operation for an uplink synchronization timer for a candidate target cell in an entire UE operation of performing an L1/L2 inter-cell handover, which may be applied to embodiments of the present disclosure.

In particular, FIG. 7 illustrates a UE operation for determining the validity of uplink synchronization and handover validity in the target cell when the UE performs handover to the target cell after receiving the LTM MAC CE.

In step 705, the UE in the connected state may receive common/dedicated configuration information for neighbor cells applied after the L1/L2-based movement is indicated through the RRC reconfiguration message from the serving cell. For a detailed configuration method and description, refer to the descriptions of FIGS. 4, 6A, and 6B.

Upon receiving the configuration, the UE may receive a PDCCH order indicating an early TA (early RACH) operation in step 710, and the PDCCH order may include an index of an LTM candidate cell for which the early TA is to be performed. The UE transmits (msg1) a random access preamble to the indicated LTM candidate cell through a preset CFRA resource for early TA. There is no RAR that is a response to the random access preamble transmitted in the corresponding step. In other words, the LTM candidate cell receives the random access preamble transmitted by the UE through the preset CRFA resource to thereby perform uplink synchronization on the corresponding cell, and stores and manages the synchronization value for the TAG to which the corresponding cell belongs in the successful synchronization. For reference, there is no separate UE operation because the UE receives the TA value through a separate signal from the LTM candidate cells or does not receive whether there is TA validity before receiving the LTM MAC CE through the above-described operation.

In step 715, the UE performs L1 resource measurement and reporting according to the L1 measurement and report configuration for the configured LTM candidate cells. For detailed operations, FIGS. 4, 6A, and 6B described above are referred to.

In step 720, the UE may receive the LTM MAC CE and may perform subsequent operations differently depending on which values are indicated in the corresponding signaling. In particular, a different operation may be performed depending on whether the LTM MAC CE includes an indicator indicating whether to perform random access (RACH-less handover indication) or a valid TA value (725). When the LTM MAC CE includes at least one of the valid TA value or the RACH-less handover indicator, the UE applies the TA value indicated to the indicated target cell in step 730 and performs the RACH-less handover operation to the target cell. In this case, the preset corresponding cell configuration is applied to timer driving and RRC. For reference, the timer driving and the detailed LTM MAC CE signaling information may be operations related to T3XX (T304 similar timer) and T3YY (TA validity determination timer applied in the LTM target cell) described with reference to FIG. 6B, and for the detailed operation, FIG. 6B is referred to. In this case, when the valid TA value for the target cell where the handover is performed is transferred to the LTM MAC CE and the corresponding TA value is applied, the random access process may be omitted, and thus the uplink interruption time may be significantly reduced.

Further, e.g., the current serving cell and the target cell may have the same uplink synchronization, and even when they belong to the same DU, the TA value may be indicated as 0 or the RACH-less handover indicator may be set and indicated as true. In other words, the corresponding operation may be indicated under the assumption that the base station has the same synchronization for the target cell and the serving cell, and in this case, the UE applies the uplink synchronization in the serving cell as it is. Alternatively, a specific serving cell and a TAG index may be transferred together and indicated to the reference cell and the TAG.

In step 735, when the uplink TA timer T3YY expires, the UE performs the timer expiration operation described with reference to FIG. 6B. In other words, operations such as PUCCH/SRS release, HARQ buffer flush, etc. are performed. Alternatively, in this step, random access for obtaining new uplink synchronization by receiving a PDCCH order from the base station before the expiration of the uplink TA timer T3YY may be triggered.

In step 725, when the valid TA value or RACH-less handover indicator is not included in the LTM MAC CE from the base station, the UE may perform the random access operation to the indicated target cell while performing handover. Further, when handing over to the corresponding target cell, a pre-configured configuration for the corresponding cell may be applied from the base station. Since random access is also performed in this operation, the UE may obtain a valid TA value after the random access to the target cell (through RAR or TA command MAC CE), and may perform an operation of maintaining the corresponding value according to a preset TA timer in RRC.

In step 745, when the uplink TA timer expires, the UE may perform a conventional uplink TA timer expiration operation. The TA timer expiration operation may include at least one of PUCCH/SRS release and HARQ buffer flush. According to one embodiment, in step 745, random access for obtaining new uplink synchronization by receiving the PDCCH order from the base station before the uplink TA timer expires may be triggered.

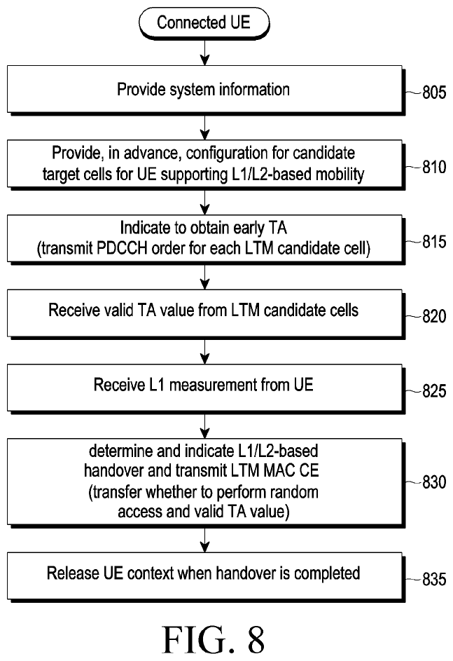

FIG. 8 illustrates a view of a base station operation applied to embodiments of the present disclosure.

In step 805, the base station provides system information to the UE, and in step 810, the base station transfers common/dedicated configuration information for a neighbor cell applied after the L1/L2-based movement is indicated through an RRC reconfiguration message from the serving cell to the UE in the connected state. For a detailed configuration method and description, refer to the descriptions of FIGS. 4, 6A, and 6B. In particular, in the disclosure, among the configuration information for the cells where L1/L2 handover is applied in the corresponding configuration, an early TA-related configuration and indication for performing uplink synchronization on the candidate cells in advance are included.

In the corresponding step, the base station may perform coordination related to whether to indicate early TA and LTM configuration, with neighbor LTM candidate cells. This may be performed through an Xn or F1 interface and an inter-node RRC message (CG-ConfigInfo, CG-Config), or the like.

In step 815, the source base station (serving cell) may transfer a PDCCH order for triggering an early TA procedure to the UE for LTM candidate cells requiring early TA. In other words, the LTM candidate cell index is included in the PDCCH order to instruct the UE to transmit the random access preamble for the early TA to the corresponding target cell. The random access preamble resource used in this case configures the CFRA resource for the LTM candidate cells in step 810. Each LTM candidate cell receives the random access preamble from the UE through the PDCCH order indicated in the above step, calculates the uplink TA based thereon, and transfers the same to the serving cell. In step 820, the base station (serving cell) may receive a valid TA value with the UE from each of the LTM candidate cells, and may store and/or manage the same.

In step 825, the L1 measurement value is received from the UE, and in this case, the measurement value may be a report on a neighbor cell (non-serving cell) supporting L1/L2-based mobility, i.e., LTM candidate cell. The serving cell may determine whether the UE performs a beam change and handover based on the received measurement result and, when it is determined that a change and handover to a specific beam of the neighbor cell, rather than a specific beam of the serving cell, is required, indicate a cell and beam change of the UE through the LTM MAC CE in step 830. In the corresponding step, whether to perform random access on the cell where handover occurs through L1/L2 signaling may be indicated simultaneously with whether to change the beam and transfer of TA value.

When the handover is indicated, the serving cell may perform a handover procedure, and when the handover with the target cell is completed in step 830, the serving cell may delete the UE context and release the connection. The measurement value for whether to determine handover is characterized by being an L1 measurement.

According to one embodiment, steps 815 and 820 may occur as frequently as necessary. In other words, when the base station determines that the TA value with the UE is not valid, it may retrigger, reobtaining TA. Conversely, even if it is determined that the TA value is not valid for a specific LTM candidate cell, the base station may omit the early TA procedure for triggering the random access. In this case, the base station may indicate the LTM handover through signaling such as indicating the RACH-less handover indicator as false without including a valid TA value in the LTM MAC CE.

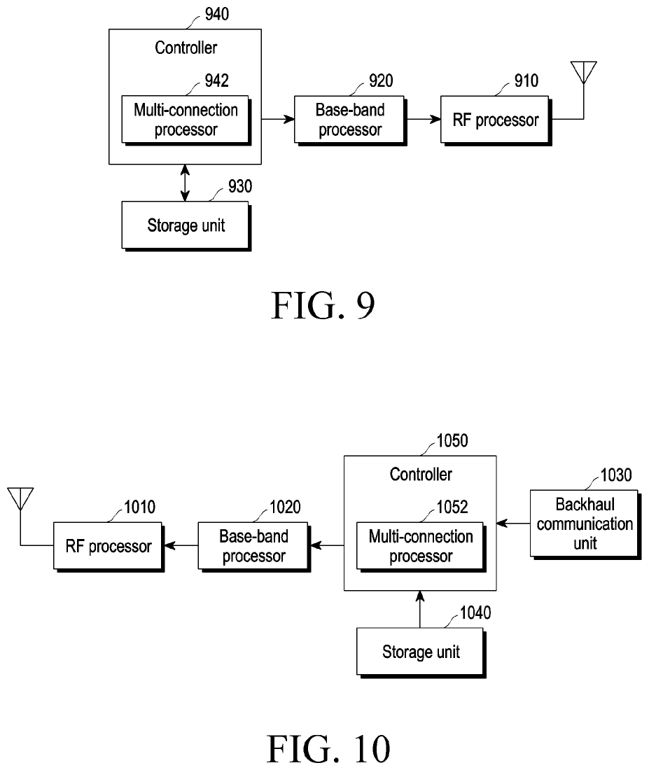

FIG. 9 illustrates a block diagram of an inner structure of a UE according to an embodiment of the present disclosure.

Referring to the figure, the UE includes a radio frequency (RF) processor 910, a baseband processor 920, a storage unit 930, and a controller 940.

The RF processor 910 performs a function for transmitting and receiving a signal through a radio channel such as band conversion and amplification of a signal. In other words, the RF processor 910 up-converts the baseband signal provided from the baseband processor 920 into an RF band signal, transmits it through the antenna, and down-converts the RF band signal received through the antenna into a baseband signal. For example, the RF processor 910 may include, e.g., a transmission filter, a reception filter, an amplifier, a mixer, an oscillator, a digital-to-analog converter (DAC), and an analog-to-digital converter (ADC). In the figure, only one antenna is shown, but the UE may include a plurality of antennas. The RF processor 910 may include multiple RF chains. Further, the RF processor 910 may perform beamforming. For beamforming, the RF processor 910 may adjust the phase and magnitude of each of the signals transmitted/received through the plurality of antennas or antenna elements. Further, the RF processing unit may perform MIMO and receive several layers upon performing the MIMO operation.

The baseband processor 920 performs the function of conversion between a baseband signal and bit stream according to the system physical layer specifications. For example, upon data transmission, the baseband processor 920 encodes and modulates a transmission bit stream, thereby generating complex symbols. Further, upon data reception, the baseband processor 920 restores the reception bit stream by demodulating and decoding the baseband signal provided from the RF processor 910. For example, in the case of following the orthogonal frequency division multiplexing (OFDM) scheme, upon data transmission, the baseband processor 920 may generate complex symbols by encoding and modulating the transmission bit stream, map the complex symbols to a subcarrier, and then configures OFDM symbols through inverse fast Fourier transform (IFFT) operation and cyclic prefix (CP) insertion. Further, upon data reception, the baseband processor 920 divides the baseband signal provided from the RF processor 910 into OFDM symbol units, restores the signals mapped to the subcarriers through fast Fourier transform (FFT) operation, and then restores the reception bit stream through demodulation and decoding.

The baseband processor 920 and the RF processor 910 may transmit and receive signals as described above. Accordingly, the baseband processor 920 and the RF processor 910 may be referred to as a transmitter, a receiver, a transceiver, or a communication unit. Further, at least one of the baseband processor 920 and the RF processor 910 may include a plurality of communication modules for supporting a plurality of different radio access technologies. Further, at least one of the baseband processor 920 and the RF processor 910 may include different communication modules for processing signals in different frequency bands. For example, the different radio access technologies may include, e.g., wireless LAN (e.g., IEEE 802.11) or cellular network (e.g., LTE). Further, the different frequency bands may include a super-high frequency (SHF) (e.g., 2.NRHz or NRHz) band or millimeter wave (mm Wave) (e.g., 60 GHz) band.

The storage unit 930 stores a basic program for operating the UE, application programs, configuration information, or other data. In particular, the storage unit 930 may store information related to the second access node performing wireless communication using the second radio access technology. Further, the storage unit 930 provides the stored data at the request of the controller 940.

The controller 940 controls the overall operation of the UE according to one embodiment. For example, the controller 940 transmits/receives signals through the baseband processor 920 and the RF processor 910. Further, the controller 940 records and reads data in/from the storage unit 930. To that end, the controller 940 may include at least one processor. For example, the controller 940 may include a communication processor (CP) that performs control for communication and an application processor (AP) that controls an upper layer, such as an application program.

FIG. 10 illustrates a block diagram of a configuration of a base station according to the disclosure.

As shown in the figure, the base station may include an RF processor 1010, a baseband processor 1020, a backhaul communication unit 1030, a storage unit 1040, and a controller 1050.

The RF processor 1010 performs a function for transmitting and receiving a signal through a radio channel such as band conversion and amplification of a signal. In other words, the RF processor 1010 up-converts the baseband signal provided from the baseband processor 1020 into an RF band signal, transmits it through the antenna, and down-converts the RF band signal received through the antenna into a baseband signal. For example, the RF processor 1010 may include a transmission filter, a reception filter, an amplifier, a mixer, an oscillator, a DAC, and an ADC. In the figure, only one antenna is shown, but the first access node may include a plurality of antennas. The RF processor 1010 may include multiple RF chains. Further, the RF processor 1010 may perform beamforming. For beamforming, the RF processor 1010 may adjust the phase and magnitude of each of the signals transmitted/received through the plurality of antennas or antenna elements. The RF processing unit may perform downlink MIMO operation by transmitting one or more layers.

The baseband processor 1020 performs the function of conversion between a baseband signal and bit stream according to the physical layer specifications of the first radio access technology. For example, upon data transmission, the baseband processor 1020 encodes and modulates a transmission bit stream, thereby generating complex symbols. Further, upon data reception, the baseband processor 1020 restores the reception bit stream by demodulating and decoding the baseband signal provided from the RF processor 1010. For example, in the case of following the OFDM scheme, upon data transmission, the baseband processor 1020 may generate complex symbols by encoding and modulating the transmission bit stream, map the complex symbols to a subcarrier, and then configures OFDM symbols through IFFT operation and CP insertion. Further, upon data reception, the baseband processor 1020 divides the baseband signal provided from the RF processor 1010 into OFDM symbol units, restores the signals mapped to the subcarriers through the FFT, and then restores the reception bit stream through demodulation and decoding. The baseband processor 1020 and the RF processor 1010 may transmit and receive signals as described above. Accordingly, the baseband processor 1020 and the RF processor 1010 may be referred to as a transmitter, a receiver, a transceiver, a communication unit, or a wireless communication unit.

The backhaul communication unit 1030 provides an interface for communicating with other nodes in the network. In other words, the backhaul communication unit 1030 converts the bit stream transmitted from the main base station to another node, e.g., auxiliary base station or core network, into a physical signal, and converts the physical signal received from the other node into a bit stream.

The storage unit 1040 stores a basic program for operating the primary base station, application programs, configuration information, or other data. In particular, the storage unit 1040 may store, e.g., information about the bearer allocated to the connected UE and the result of measurement reported from the connected UE. Further, the storage unit 1040 may store information that serves as a reference for determining whether to provide multiple connections to the UE or stop. Further, the storage unit 1040 provides the stored data at the request of the controller 1050.

The controller 1050 controls the overall operation of the base station according to one embodiment. For example, the controller 1050 transmits and receives signals through the baseband processor 1020 and the RF processor 1010 or through the backhaul communication unit 1030. Further, the controller 1050 records and reads data in/from the storage unit 1040. To that end, the controller 1050 may include at least one processor.

Although the present disclosure has been described with various embodiments, various changes and modifications may be suggested to one skilled in the art. It is intended that the present disclosure encompass such changes and modifications as fall within the scope of the appended claims.

What is claimed is:

1. A method by a base station in a wireless communication system, the method comprising:
receiving, from a gNB-DU (distributed unit), a message related to timing advance (TA) information; and
transmitting, to a user equipment (UE), a L1/L2 triggered mobility (LTM) medium access control (MAC) control element (CE), wherein the LTM MAC CE includes at least one of candidate target configuration ID for the LTM, or timing advance command indicating a TA value.

2. The method of claim 1, wherein the timing advance command is used for the UE to skip a random access procedure for the LTM.

3. The method of claim 1, wherein a length of the timing advance command is 12 bits.

4. The method of claim 1, further comprising:
transmitting, to the gNB-DU, a configuration request message for requesting random access channel (RACH) configuration; and
receiving, from gNB-DU, a configuration response message.

5. The method of claim 1, further comprising:
transmitting, to the UE, a physical downlink control channel (PDCCH) order including an index for at least one LTM candidate cell; and
receiving a valid TA value from the at least one LTM candidate cell.

6. The method of claim 1, further comprising:
receiving, from the UE, an L1 measurement value; and
determining whether to change a beam of the UE and whether to perform handover, based on the L1 measurement value.

7. A method by a user equipment (UE) in a wireless communication system, the method comprising:
receiving, from a base station, a L1/L2 triggered mobility (LTM) medium access control (MAC) control element (CE), in case that a message related to timing advance (TA) information is transmitted from a gNB-DU (distributed unit) to the base station; and
identifying that the LTM MAC CE includes at least one of candidate target configuration ID for the LTM, or timing advance command indicating a TA value.

8. The method of claim 7, wherein the timing advance command is used for the UE to skip a random access procedure for the LTM.

9. The method of claim 7, wherein a length of the timing advance command is 12 bits.

10. The method of claim 7, further comprising:
receiving a PDCCH order including an index for at least one LTM candidate cell from the base station; and
transmitting an RACH preamble to the at least one LTM candidate cell.

11. A base station in a wireless communication system, comprising:
a transceiver; and
a controller, wherein the controller is configured to control the transceiver to:
receive, from a gNB-DU (distributed unit), a message related to timing advance (TA) information, and
transmit, to a user equipment (UE), a L1/L2 triggered mobility (LTM) medium access control (MAC) control element (CE), wherein the LTM MAC CE includes at least one of candidate target configuration ID for the LTM, or timing advance command indicating a TA value.

12. The base station of claim 11, wherein the timing advance command is used for the UE to skip a random access procedure for the LTM.

13. The base station of claim 11, wherein a length of the timing advance command is 12 bits.

14. The base station of claim 11, wherein the controller is configured to control the transceiver to:
transmit, to the gNB-DU, a configuration request message for requesting random access channel (RACH) configuration, and
receive, from gNB-DU, a configuration response message.

15. The base station of claim 11, wherein the controller is configured to control the transceiver to:
transmit, to the UE, a physical downlink control channel (PDCCH) order including an index for at least one LTM candidate cell, and
receive a valid TA value from the at least one LTM candidate cell.

16. The base station of claim 11, wherein the controller is configured to control the transceiver to:
receive, from the UE, an L1 measurement value, and
determine whether to change a beam of the UE and whether to perform handover, based on the L1 measurement value.

17. A user equipment (UE) in a wireless communication system, comprising:
a transceiver; and
a controller, wherein the controller is configured to control the transceiver to:
receive, from a base station, a L1/L2 triggered mobility (LTM) medium access control (MAC) control element (CE), in case that a message related to timing advance (TA) information is transmitted from a gNB-DU (distributed unit) to the base station, and
identify that the LTM MAC CE includes at least one of candidate target configuration ID for the LTM, or timing advance command indicating a TA value.

18. The UE of claim 17, wherein the timing advance command is used for the UE to skip a random access procedure for the LTM.

19. The UE of claim 17, wherein a length of the timing advance command is 12 bits.

20. The UE of claim 17, wherein the controller is configured to control the transceiver to:
receive a PDCCH order including an index for at least one LTM candidate cell from the base station, and
transmit an RACH preamble to the at least one LTM candidate cell.
